(19) United States
(12) Patent Application Publication
(10) Pub. No.: US 2005/0077738 A1
(43) Pub. Date: Apr. 14, 2005

(54) Multi-purpose hydraulic bumper

(76) Inventor: Allan Ray Roberts, Oakalla, TX (US)

Correspondence Address: ALLAN RAY ROBERTS, 9881 FM 2657, KEMPNER, TX, 76539, US

(21) Appl. No.: 10/940,455

(22) Filed: Sep. 13, 2004

Related U.S. Application Data
(60) Provisional application No. 60/503,344, filed on Sep. 16, 2003.

(51) Int. Cl. B60R 19/02

(52) U.S. Cl. 293/102

(57) ABSTRACT

The multi-purpose hydraulic bumper is a replacement bumper which mounts to a truck. The bumper rotates up and down with hydraulic power. This movement makes it a working piece of equipment able to do many different jobs.

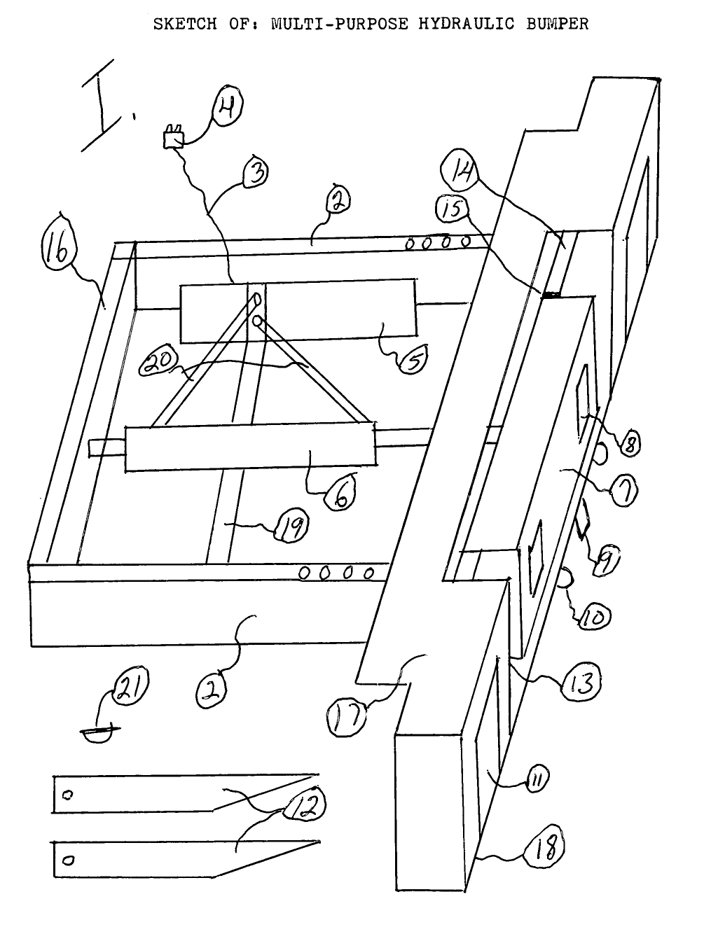

### BACKGROUND OF THE INVENTION

The field of endeavor this invention pertains to is mostly agriculture. I needed to move big round bales of hay and other heavy things without going to a lot trouble. This invention solves that problem by itself. Many different attachments can be mounted to the bumper doing many different jobs. The multi-purpose hydraulic bumper turns a single truck into many different pieces of equipment. This invention saves time and money, thus making me more productive. A more productive individual means a stronger nation.

### BRIEF SUMMARY

This replacement bumper can take the place of owning many different pieces of equipment. This bumper can do it's work without removing the original factory truck bed and also not be in the way for normal use of the truck bed.

1. What I claim as my invention is the multi-purpose hydraulic bumper that rotates up and down with power provided by a hydraulic pump and cylinder thus performing many different tasks depending upon what is attacked to it.
